(19) United States
(12) Patent Application Publication
(10) Pub. No.: US 2012/0051568 A1
(43) Pub. Date: Mar. 1, 2012

(54) METHOD AND APPARATUS FOR REPRODUCING FRONT SURROUND SOUND

(75) Inventors: Seoung-hun KIM, Hwaseong-si (KR); Young-tae KIM, Seongnam-si (KR); Sun-min KIM, Yongin-si (KR); Sang-chul KO, Seoul (KR); Jung-woo CHOI, Hwaseong-si (KR)

(73) Assignee: SAMSUNG ELECTRONICS CO., LTD., Suwon-si (KR)

(21) Appl. No.: 13/218,072

(22) Filed: Aug. 25, 2011

Related U.S. Application Data
(60) Provisional application No. 61/378,527, filed on Aug. 31, 2010.

(30) Foreign Application Priority Data
Mar. 15, 2011 (KR) 10-2011-0022885

(51) Int. Cl. H04R 5/02

(52) U.S. Cl. 381/307

(57) ABSTRACT

A method and apparatus for reproducing a front surround sound, whereby a coefficient of at least one beamforming filter set is determined based on a sound pressure ratio of an emphasis area to a suppression area for each of the at least one channel signal included in a sound signal, where the emphasis area is an area into which the at least one channel signal is focused and the suppression area is an area within which the at least one channel signal is blocked, the at least one channel signal passes through a corresponding beamforming filter set, and the at least one filtered channel signal is output through an array speaker.

### CROSS-REFERENCE TO RELATED APPLICATION

This application claims the benefit of U.S. Provisional Patent Application No. 61/378,527, filed on Aug. 31, 2010, in the U.S. Patent and Trademark Office, and priority from Korean Patent Application No. 10-2011-0022885, filed on Mar. 15, 2011, in the Korean Intellectual Property Office, the disclosures of which are incorporated herein in their entirety by reference.

### BACKGROUND

1. Field

Apparatuses and methods consistent with exemplary embodiments relate to a reproducing a front surround sound, by which a three-dimensional sound is provided by reproducing a multi-channel sound signal by using an apparatus for reproducing a front surround sound.

2. Description of the Related Art

Sound technology addresses the issue of the reproduction of a three-dimensional sound through the reproduction of a mono sound and a stereo sound. In particular, a method of providing a three-dimensional sound by using a 5.1-channel speaker or providing a virtual three-dimensional sound by using a 2-channel speaker and Head-Related Transfer Functions (HRTFs) may be used.

However, although a method of generating a virtual sound source may be effective in a low frequency band, the method is not effective in a high frequency band.

### SUMMARY

One or more exemplary embodiments may provide a method and apparatus for reproducing a front surround sound.

According to an aspect of an exemplary embodiment, there is provided a method of reproducing a front surround sound, the method including: determining a coefficient of at least one beamforming filter set based on a sound pressure ratio of an emphasis area to a suppression area for each of the at least one channel signal included in a sound signal, where the emphasis area is an area into which the at least one channel signal is focused and the suppression area is an area within which the at least one channel signal is blocked; passing the at least one channel signal through a corresponding beamforming filter set; and outputting the at least one filtered channel signal through an array speaker.

The array speaker may include a plurality of speakers, and the beamforming filter set may include a plurality of filters corresponding to the plurality of speakers, and the outputting may include outputting the at least one filtered channel signal through a corresponding one of the plurality of speakers.

The method may further include acquiring a high frequency sound signal from the sound signal, the high frequency signal including a frequency component equal to or greater than a threshold frequency, wherein the passing includes passing the high frequency sound signal through the corresponding beamforming filter set.

The sound signal may include residual channel signals and a center channel signal, and the passing may include passing the residual channel signals al through the beamforming filter sets corresponding to the residual channel signals, and the outputting may include adding the residual channel signals, which have passed through the beamforming filter set, and the center channel signal and outputting the added signal through the array speaker.

The determining may include determining the coefficient of the beamforming filter set based on the sound pressure ratio of the emphasis area to the suppression area and a sound pressure efficiency in the emphasis area for each of the at least one channel signal.

The determining may include setting the emphasis area and the suppression area for each of the at least one channel signal.

The determining may include determining the coefficient so that a phase difference between output signals acquired by applying the same input signal to the plurality of filters in the beamforming filter set varies nonlinearly.

The method may further include: passing the sound signal through a virtualization filter for localizing at least one virtual sound source in a predetermined location; and outputting the sound signal, which has passed through the virtualization filter, through a woofer speaker.

The passing of the sound signal through the virtualization filter may include cancelling a crosstalk between the at least one virtual sound source localized at the predetermined location; and compensating for a signal characteristic between the sound signal and the at least one virtual sound source from which the crosstalk is cancelled.

The cancelling of the crosstalk may include generating at least one virtual sound source by convoluting Head-Related Transfer Functions (HRTFs) measured in the predetermined location and the sound signal.

According to an aspect of another exemplary embodiment, there is provided an apparatus for reproducing a front surround sound, the apparatus including: a coefficient determiner which determines a coefficient of at least one beamforming filter set, based on a sound pressure ratio of an emphasis area to a suppression area for each of the at least one channel signal included in a sound signal, where the emphasis area is an area into which the at least one channel signal is focused and the suppression area is an area within which the at least one channel signal is blocked; a beamforming filtering unit comprising at least one beamforming filter set through which a corresponding at least one channel signal is passed; and an output unit which outputs the at least one filtered channel signal through an array speaker.

### BRIEF DESCRIPTION OF THE DRAWINGS

The above and/or other aspects will become more apparent by describing in detail exemplary embodiments with reference to the attached drawings in which:

FIG. 1 is a block diagram of a front surround sound apparatus according to an exemplary embodiment;

FIG. 2 is a block diagram of a beamforming unit according to an exemplary embodiment;

FIG. 3 is a block diagram of a beamforming filtering unit according to an exemplary embodiment;

FIG. 4 is a block diagram of a high pass filter according to an exemplary embodiment;

FIGS. 5A-5D are block diagrams of Finite Impulse Response (FIR) filters according to an exemplary embodiment;

FIG. 6 is a block diagram of a mixer according to an exemplary embodiment;

FIG. 7 is an illustration of outputting a sound signal in the beamforming unit according to an exemplary embodiment;

FIG. 8 is a block diagram of a coefficient determiner according to an exemplary embodiment;

FIG. 9 is a diagram for describing a response model of an array speaker according to an exemplary embodiment;

FIG. 10 is a graph for describing a method of determining a weight for a cost function in a sound pressure controller according to an exemplary embodiment;

FIG. 11 is a flowchart illustrating a process of calculating a filter coefficient in an apparatus for reproducing a front surround sound according to an exemplary embodiment;

FIG. 12 is a block diagram of a virtualization unit according to an exemplary embodiment;

FIG. 13 is a block diagram of a localizing unit according to an exemplary embodiment;

FIG. 14 is a block diagram of an apparatus for reproducing a front surround sound according to an exemplary embodiment; and

FIG. 15 is a flowchart illustrating a method of reproducing a front surround sound according to an exemplary embodiment.

### DETAILED DESCRIPTION

Exemplary embodiments will now be described more fully with reference to the accompanying drawings.

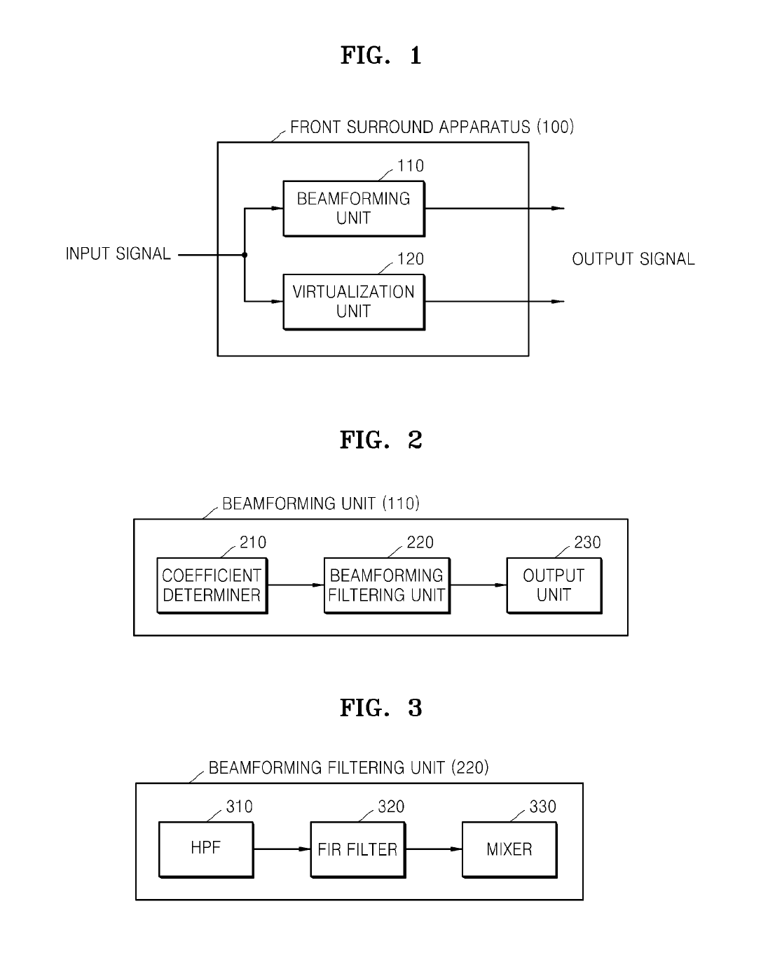

FIG. 1 is a block diagram of a front surround sound apparatus 100 according to an exemplary embodiment.

Referring to FIG. 1, the front surround apparatus 100 is a device for reproducing a three-dimensional sound with only a front speaker and not a side or rear speaker.

The front surround apparatus 100 may include at least one of a beamforming unit 110 and a virtualization unit 120.

The beamforming unit 110 may extract only a high frequency component having a frequency equal to or greater than a threshold frequency from a sound signal and induces a reflection sound signal by focusing the high frequency component at a predetermined location. If the reflection sound signal arrives at a listener, the listener may enjoy a three-dimensional sound due to the perception that the source of the sound at the predetermined location at which the reflection sound is generated. As described above, when the beamforming unit 110 is used, a surround channel signal may be effectively provided by using a speaker disposed in front of the listener.

The virtualization unit 120 may localize a virtual sound source at a predetermined location by changing a gain or phase of the sound signal. According to an exemplary embodiment, the virtualization unit 120 may localize the virtual sound source by using a full band component of the sound signal, and according to another exemplary embodiment, the virtualization unit 120 may localize the virtual sound source by using only a low frequency component of the sound signal which is less than the threshold.

FIG. 2 is a block diagram of the beamforming unit 110 according to an exemplary embodiment.

Referring to FIG. 2, the beamforming unit 110 may include a coefficient determiner 210, a beamforming filtering unit 220, and an output unit 230.

The coefficient determiner 210 may determine a coefficient of a beamforming filter set for each of at least one channel signal included in the sound signal. A beamforming filter is a filter for processing the sound signal and focusing the processed sound signal at a predetermined location. When the sound signal, which has passed through the beamforming filter, is output to corresponding speakers in an array speaker, the delivery of the sound signal may be concentrated in a specific direction due to piling-up or canceling of signals. In this description, an area on which the sound signal is focused (or an area in which the delivery of a sound is emphasized) is called an emphasis area or a positive part, and an area to which the sound signal is not delivered (or an area in which the delivery of a sound is suppressed) is called a suppression area or a negative part.

The beamforming filter set may include beamforming filters corresponding to the number of speakers in the array speaker, and each of the beamforming filters in the beamforming filter set may correspond to one of the speakers in the array speaker, respectively. Thus, the coefficient determiner 210 may determine a beamforming filter coefficient corresponding to each of the number of speakers in the array speaker. For example, it is assumed that the sound signal includes a 5.1-channel signal, 4 channel signals pass through the beamforming filters, and the array speaker includes 10 speakers. In this case, since a single channel signal passes through 10 beamforming filters, the coefficient determiner 210 may calculate 40 (4×10) beamforming filter coefficients.

The coefficient determiner 210 may determine a coefficient of a beamforming filter set based on a level difference between a sound pressure in the emphasis area and a sound pressure in the suppression area. The sound pressure level difference may be represented by a ratio of the sound pressure in the emphasis area to the sound pressure in the suppression area, wherein a large sound pressure ratio indicates that sound energy delivered to the emphasis area is relatively greater than sound energy delivered to the suppression area. Thus, if the ratio of the sound pressure in the emphasis area to the sound pressure in the suppression area is large, it may be determined that the sound signal is well focused on the emphasis area.

The coefficient determiner 210 may determine the coefficient of the beamforming filter set by further considering an efficiency of the sound pressure in the emphasis area. The sound pressure efficiency may be represented by a ratio of the magnitude of a sound pressure of an output signal to the magnitude of an input signal. The output signal indicates the signal acquired within the emphasis area. Since a high sound pressure efficiency indicates that most of the input signal is delivered to the emphasis area while minimizing a loss of the input signal, if the sound pressure efficiency is high, it may be determined that the sound signal is well focused on the emphasis area.

If the coefficient determiner 210 determines the filter coefficients by considering only the sound pressure ratio, an absolute sound pressure in the emphasis area is not considered. Thus, even though the sound signal may be well focused on the emphasis area by properly adjusting the ratio of the sound pressure in the emphasis area to the sound pressure in the suppression area, the absolute sound pressure in the emphasis area may be too small for a user to hear a three-dimensional sound. In addition, if the coefficient determiner 210 determines the filter coefficients by considering only the sound pressure ratio, unnecessary control energy may be used to cancel the sound signal delivered to the suppression area.

To address these issues, a method of increasing an absolute sound pressure of energy delivered to the emphasis area in comparison to energy used for a control may be used. According to this method, however, a sound pressure level in an area (including the suppression area) excluding the emphasis area may be high. Since an array speaker having a significantly long wavelength must be used to control such a high sound pressure level, this may be problematic.

Thus, the coefficient determiner 210 may determine coefficients of the beamforming filters by considering both the sound pressure ratio and the sound pressure efficiency.

The coefficient determiner 210 may set the emphasis area and the suppression area for each channel signal included in the sound signal. However, for a channel signal, which does not pass through a beamforming filter, the emphasis area and the suppression area are not be set. Alternatively, the coefficient determiner 210 may set only the emphasis area, without setting the suppression area, or may set one or more emphasis areas or suppression areas.

The emphasis area and the suppression area may be directly set by the user inputting coordinates, by the coefficient determiner 210 or the user selecting one of a plurality of pre-set areas, or by the coefficient determiner 210 perceiving a structure of a space into which the sound signal is output. For example, the coefficient determiner 210 may perceive a structure of a space within which the array speaker is disposed by outputting one or more pilot signals to the space to which the sound signal is output. The coefficient determiner 210 may directly set the emphasis area and the suppression area for each channel signal based on the structure of the space within which the array speaker is disposed and a location of the listener. For example, in order for a left front channel signal to be generated at a left front side of the listener, the coefficient determiner 210 may set a wall located on the left of the listener as the emphasis area and may focus the left front channel signal on the emphasis area.

Location information of the emphasis area and the suppression area may be represented by specific coordinate values or by information regarding a distance and direction from the array speaker.

The beamforming filtering unit 220 may pass at least one channel signal through a corresponding beamforming filter set. It has been described that the beamforming filter set may include beamforming filters corresponding to the number of speakers forming the array speaker. According to an exemplary embodiment, the beamforming filtering unit 220 may extract only a high frequency component from at least one channel signal and pass the extracted high frequency component through the beamforming filter set.

The beamforming filtering unit 220 may mix signals to be output to the same speaker from among channel signals, which have passed through the beamforming filters. For example, it is assumed that the array speaker includes 10 speakers and 4 channel signals, excluding a center signal from among 5 channel signals included in a sound signal, passing through the beamforming filters. The beamforming filtering unit 220 may pass the 4 channel signals through the beamforming filters, mix the signals to be output to the same speaker, and output the mixed signal to a corresponding speaker. According to an exemplary embodiment, the beamforming filtering unit 220 may mix channel signals, which have passed through the beamforming filters, and a center signal (or a center signal amplified or diminished with a predetermined gain) and output the mixed signal to a corresponding speaker.

The output unit 230 may output at least one filtered channel signal to corresponding speakers forming the array speaker.

FIG. 3 is a block diagram of the beamforming filtering unit 220 according to an exemplary embodiment.

Referring to FIG. 3, the beamforming filtering unit 220 may include a high pass filter (HPF) 310, a Finite Impulse Response (FIR) filter 320, and a mixer 330.

The HPF 310 is a filter for extracting a high frequency component from at least one channel signal included in a sound signal. The HPF 310 may set different threshold frequencies to be applied to each of the at least one channel signal. Alternatively, for convenience of design, the HPF 310 may set the same threshold frequency to be applied to all of the at least one channel signal.

By properly adjusting a coefficient of the FIR filter 320, each of the at least one channel signal, which has passed through the FIR filter 320, may be focused in a desired direction. The coefficient of the FIR filter 320 may be determined based on a sound pressure efficiency and a sound pressure ratio. Since the FIR filter 320 determines the coefficient of the FIR filter 320 based on the sound pressure efficiency and the sound pressure ratio without simply changing a phase or gain of an input signal, a phase difference of two filtered channel signals to be output to adjacent speakers by passing through the FIR filter 320 is nonlinear.

The mixer 330 may mix channel signals to be output to the same speaker from among channel signals, which have passed through the FIR filter 320. According to an exemplary embodiment, some channel signals included in a sound signal may not pass through the FIR filter 320, and in this case, the mixer 330 may mix the channel signals to be output to the same speaker from among the channel signals, which have passed through the FIR filter 320, and one or more channel signals, which have not passed through the FIR filter 320. The mixer 330 may amplify or diminish a plurality of mixed channel signals with different gains to adjust a mixing ratio of the plurality of mixed channel signals.

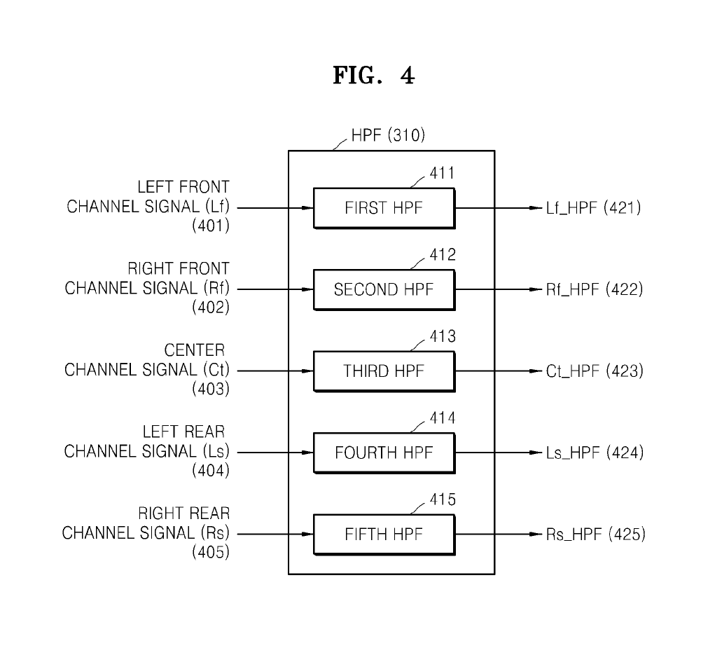

FIG. 4 is a block diagram of the HPF 310 according to an exemplary embodiment.

Referring to FIG. 4, a sound signal may include a left front channel signal Lf 401, a right front channel signal Rf 402, a center channel signal Ct 403, a left rear channel signal Ls 404, and a right rear channel signal Rs 405. Although it is assumed in FIG. 4 that the sound signal is a 5.1-channel sound signal, the sound signal may be a 6.1- or 7.1-channel sound signal according to other exemplary embodiments.

First, second, third, fourth, and fifth HPFs 411, 412, 413, 414, and 415 may extract only high frequency components 421, 422, 423, 424, and 425 equal to or greater than the threshold frequency from the channel signals 401, 402, 403, 404, and 405, respectively.

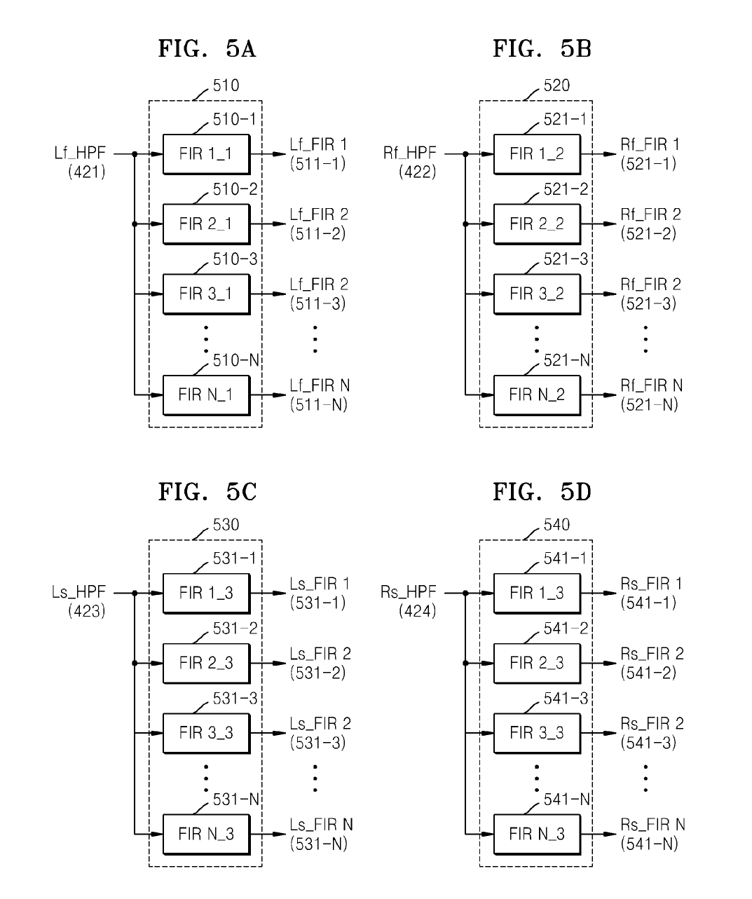

FIG. 5 is a block diagram of the FIR filter 320 according to an exemplary embodiment.

It is assumed in FIG. 5 that the high frequency components 421, 422, 424, and 425, which are the components remaining by excluding the high frequency component 423 of the center channel signal Ct 403 from among the high frequency components 421, 422, 423, 424, and 425 acquired by passing through the first, second, third, fourth, and fifth HPFs 411, 412, 413, 414, and 415, pass through the FIR filter 320.

The FIR filter 320 may include 4 FIR filter sets, wherein a single FIR filter set corresponds to a single channel signal.

FIG. 5(a) is a block diagram of an FIR filter set 510 for filtering the high frequency component 421 of the left front channel signal Lf 401, FIG. 5(b) is a block diagram of an FIR filter set 520 for filtering the high frequency component 422 of the right front channel signal Rf 402, FIG. 5(c) is a block diagram of an FIR filter set 530 for filtering the high frequency component 424 of the left rear channel signal Ls 404, and FIG. 5(d) is a block diagram of an FIR filter set 540 for filtering the high frequency component 425 of the right rear channel signal Rs 405.

Each of the FIR filter sets 510, 520, 530, and 540 may include FIR filters corresponding to the number of speakers forming the array speaker. It is assumed in FIG. 5 that the array speaker includes N speakers.

Referring to FIG. 5(a), the high frequency component 421 of the left front channel signal Lf 401 may be duplicated by N and input to N FIR filters 510-1, 510-2, . . . , 510-N forming the FIR filter set 510. The FIR filter set 510 may output N filtered left front channel signals 511-1, 511-2, . . . , 511-N. Since the N FIR filters 510-1, 510-2, . . . , 510-N determine filter coefficients by considering both a sound pressure ratio and a sound pressure efficiency without simply changing a gain and phase of an input signal, a phase difference between neighboring output signals is not linearly changed. That is, a phase difference between Lf_FIR1 511-1 and Lf_FIR2 511-2, a phase difference between Lf_FIR2 511-2 and Lf_FIR3 511-3, and a phase difference between Lf_FIR3 511-3 and Lf_FIR4 511-4 are nonlinearly changed.

Since FIGS. 5(b) to 5(d) are identical to FIG. 5(a) except for their input signals, a description thereof is omitted.

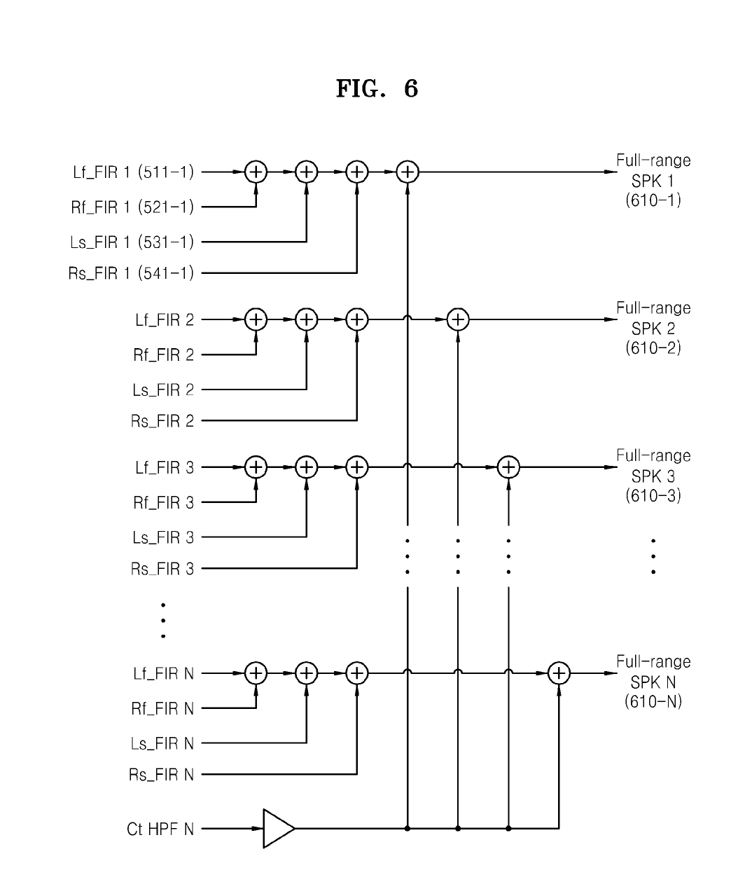

FIG. 6 is a block diagram of the mixer 330 according to an exemplary embodiment.

Referring to FIG. 6, the mixer 330 may mix channel signals to be output to the same speaker from among channel signals, which have passed through the beamforming filter 220.

In this description, only a process of generating an output signal output to a first speaker 610-1 in the mixer 330 is described.

The mixer 330 may mix Lf_FIR1 511-1, Rf_FIR1 521-1, Ls_FIR1 531-1, and Rs_FIR1 541-1, which have passed through the beamforming filter 220, and Ct_HPF 423, which has not passed through the beamforming filter 220. According to an exemplary embodiment, the mixer 330 may amplify or diminish Ct_HPF 423 with a predetermined gain and mix it and Lf_FIR1 511-1, Rf_FIR1 521-1, Ls_FIR1 531-1, and RsFIR14 541-1.

Accordingly, an output signal output to an Nth speaker 610-N, which is mixed by the mixer 330, may be calculated based on Equation 1 below.

Output signal=Lf_{—}FIRN 511-N+Rf_{—}FIRN 521-N+Ls_{—}FIRN 531-N+Rs_{—}FIRN 541-N+Ct_{—}HPF 423×A (1)

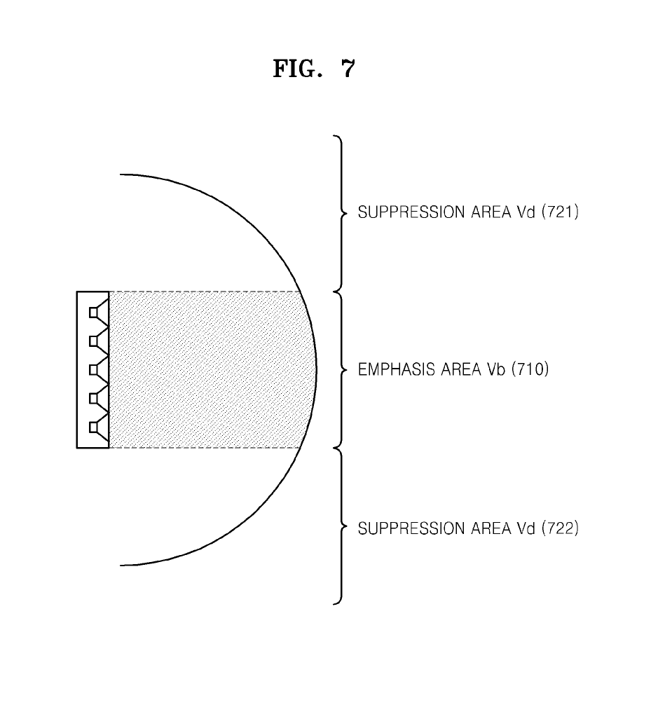

FIG. 7 is an illustration of outputting a sound signal in the beamforming unit 110 according to an exemplary embodiment.

The beamforming unit 110 may filter a sound signal by using the beamforming filters and output the filtered sound signal through the array speaker including a plurality of speakers. The beamforming unit 110 may determine an emphasis area 710 for each channel, focus the sound signal onto the emphasis area 710, and adjust coefficients of the beamforming filters not to deliver the sound signal to suppression areas 721 and 722 so that the listener perceives that the sound signal is generated at both sides and at the rear. The sound signal, which has passed through the beamforming filters, may be focused on the emphasis area 710 for each channel to generate a reflection signal, and the listener may thereby perceive a three-dimensional sound via the reflection signals.

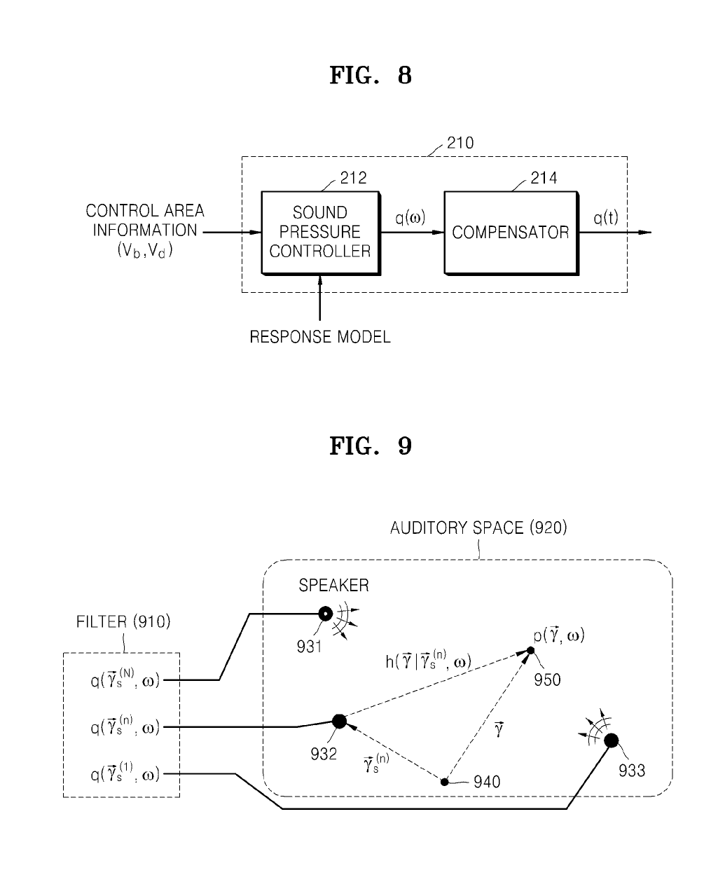

FIG. 8 is a block diagram of the coefficient determiner 210 according to an exemplary embodiment.

Referring to FIG. 8, the coefficient determiner 210 may include a sound pressure controller 212 and a compensator 214.

The sound pressure controller 212 may receive control area information (including an emphasis area and a suppression area) and determine a coefficient of a filter for controlling a sound pressure based on a sound pressure ratio and a sound pressure efficiency calculated from a response model between the array speaker and control areas. That is, the sound pressure ratio and the sound pressure efficiency, which are criteria for determining focusing, described above, are criteria for determining the filter coefficient in the current embodiment. Here, the response model is obtained by discovering a relationship between a specific input and an output and modeling the relationship as a standardized expression such as a transfer function. In the current embodiment, a sound signal output from the array speaker may correspond to the input, and a sound signal at a position (hereinafter, used as ‘field point’), which is an arbitrary distance apart from the array speaker, may correspond to the output. That is, the response model is obtained by representing a relationship of how much sound pressure the sound signal output from the array speaker has at a field point, which is a specific distance apart from the array speaker, as a function of a physical variable between both positions.

To obtain the response model of the sound signal radiated through the array speaker, a theoretical method, an experimental method, or an analytical method may be used. Since each of the methods can be easily understood by those of ordinary skill in the art, only a simple outline of the theoretical method and the experimental method, which are representative methods, is described herein.

First, in the theoretical method, a sound model is made by using a sound propagation relational expression between positions, which are arbitrary distances apart from the array speaker. If a sound pressure at a single field point, which is a specific distance apart from a single sound source for the array speaker, is defined, a sound pressure formed through a plurality of sound sources, i.e., the array speaker, may be obtained by integrating the defined sound pressure over the magnitude of the array speaker.

Second, in the experimental method, a specific sound source signal is applied to one of the individual speakers forming the array speaker and output from the corresponding speaker. Here, the specific sound source signal indicates a test sound source used to measure a radiated sound source signal, and an impulse signal or white noise, in which all frequency components are uniformly included, may be used as the specific sound source signal. At a field point, which is an arbitrary distance apart from the array speaker, the specific sound source signal output from the corresponding speaker is measured by using a measuring instrument such as a microphone array. By repeatedly performing the above-described measuring process for the plurality of speakers forming the array speaker, a response model regarding a sound pressure of the total array speaker may be defined based on the measured signals.

The sound pressure controller 212 may calculate a coefficient of a filter for controlling a sound field based on the obtained response model. Here, since the filter for controlling a sound field is a multi-channel filter corresponding to the number of output channels of the array speaker, the calculation of the filter coefficient indicates the calculation of a plurality of channel coefficients. A process of calculating the coefficients of the multi-channel filter is described in more detail with reference to FIGS. 9 to 11.

FIG. 9 is a diagram for describing a response model of an array speaker according to an exemplary embodiment, which conceptually shows a multi-channel array speaker system in a frequency domain. In FIG. 9, signals filtered through a beamforming filter 910 are applied to a plurality of speakers 931, 932, and 933 forming the array speaker. The beamforming filter 910 includes a plurality of FIR filters, wherein the plurality of FIR filters correspond to the plurality of speakers 931, 932, and 933 forming the array speaker, respectively.

If the signals applied to the plurality of speakers 931, 932, and 933 are radiated, the signals may be represented by the sound pressure at an arbitrary field point 950 according to a response model of the array speaker. When a sound is output from the plurality of speakers 931, 932, and 933, the sound pressure at the arbitrary field point 950, which is y apart from an origin 940 indicating the center of the array speaker, may be represented by a multiplication of the response model of the array speaker by a filter coefficient, and a sum of sound pressures of the plurality of individual speakers forming the array speaker may be defined by Equation 2 below.

p(\vec{γ},ω)=Σₙ₌₀^{N-1}h(\vec{γ}|\vec{γ}ₛ⁽ⁿ⁾,ω)q⁽ⁿ⁾(ω) (2)

Here, p(\vec{γ}, ω) denotes a sound pressure, \vec{γ} denotes a vector from the origin 940 to the field point 950, ω denotes a frequency, h(\vec{γ}|\vec{γ}ₛ⁽ⁿ⁾,ω) denotes a response model of an array speaker, and q⁽ⁿ)(ω) denotes a coefficient of a multi-channel filter, which corresponds to an nth speaker among the plurality of individual speakers forming the array speaker. That is, Equation 2 indicates a sound pressure of a sound signal output from the array speaker.

The sound pressure of Equation 2 is represented as a vector defined by Equation 3.

p(\vec{γ},ω)=h)(\vec{γ}|\vec{γ}ₛ)q (3)

A sound pressure ratio and a sound pressure efficiency, which are criteria for determining a coefficient of a filter, described above will now be calculated by using the sound pressure represented as the vector defined by Equation 3. To do this, the sound pressure in a control area is represented through an average of sound energy. Here, the average may be obtained by calculating an arithmetic mean using a field point of the control area, which has been set.

An average of the sound energy in an emphasis area may be represented by Equation 4 below.

$$\begin{matrix}{e}_{b} = {〈 {\vert p ( {γ}^{->} , ω ) \vert}^{2} 〉}_{{v}_{b}} \\ = {q}^{H} \frac{1}{{V}_{b}} {\int }_{{V}_{b}} {h ( {γ}^{->} \vert {{γ}^{->}}_{g} )}^{H} h ( {γ}^{->} \vert {{γ}^{->}}_{s} ) d Vq \\ = {q}^{H} {R}_{b} q\end{matrix} \qquad ( 4 )$$

Here, h(\vec{γ}|\vec{γ}ₛ)^{H} denotes an Hermitian transpose matrix of h(\vec{γ}|\vec{γ}ₛ), R_{b} denotes a spatial correlation, and V_{b} denotes an emphasis area. Equation 4 indicates an average of sound energy, which is calculated from the sound pressure of the emphasis area.

The sound pressure efficiency, which is the second criterion for determining the filter coefficient to be used in exemplary embodiments described herein, is represented as Equation 5 by using Equation 4. The sound pressure efficiency of Equation 5 is defined as a ratio of the magnitude of energy in the emphasis area to the magnitude of energy (indicating a sound pressure) of the input signal.

$$α = \frac{{e}_{b}}{{e}_{bmax}} = \frac{{q}^{H} {R}_{b} q}{{‖ {R}_{b} ‖}^{2} {q}^{H} q} \qquad ( 5 )$$

Here, α denotes a sound pressure efficiency, e_{bmax} denotes maximum sound energy, which can be generated in the emphasis area from the input signal, and ∥R_{b}∥² denotes sound energy, which can be generated from a unit input power, and is a variable introduced to match physical amounts of the numerator and the denominator with energy.

The sound pressure ratio, which is the first criterion for determining the filter coefficient, is represented as Equation 6 by using Equation 4. The sound pressure ratio of Equation 6 is defined as a ratio of the magnitude of energy in the emphasis area to the magnitude of energy (indicating a sound pressure) in the suppression area.

$$β = \frac{{e}_{b}}{{e}_{d}} = \frac{{q}^{H} {R}_{b} q}{{q}^{H} {d}_{d} q} \qquad ( 6 )$$

Here, β denotes a sound pressure ratio, e_{d} denotes energy in the suppression area, and e_{b} denotes energy in the emphasis area.

If the sound pressure efficiency of Equation 5 and the sound pressure ratio of Equation 6 are independently used, issues may arise as described above. That is, a high sound pressure level may occur even in an area outside the emphasis area if the sound pressure efficiency of Equation 5 is used, and a very large sound pressure ratio may be calculated if only the sound pressure ratio of Equation 6 is used, even if e_{b}, is very small as e_{d} approaches 0.

Thus, according to an exemplary embodiment, a cost function having the advantages of both the sound pressure efficiency and the sound pressure ratio may be calculated by determining a coefficient of a filter by combining both the sound pressure efficiency and the sound pressure ratio. The cost function is obtained by weighting the two criteria for determining the coefficient of the filter and combining the weighted criteria. The cost function may be represented by Equation 7.

$$\begin{matrix}γ = \frac{{e}_{b}}{( 1 - K ) {e}_{d} + {ke}_{bmax}} \\ = \frac{{q}^{H} {R}_{b} q}{( 1 - k ) {q}^{H} {R}_{d} q + k {‖ {R}_{b} ‖}^{2} {q}^{H} q}\end{matrix} \qquad ( 7 )$$

Here, γ denotes the cost function, and a denominator of the cost function is obtained by combining the energy e_{d} in the suppression area, which is the denominator of the sound pressure ratio, and the maximum sound energy e_{bmax}, i.e., the denominator of the sound pressure efficiency, which can be generated in the emphasis area from the input signal. Although both the sound pressure efficiency and the sound pressure ratio are combined based on a weighting coefficient k in Equation 7, the cost function may be variously designed by those of ordinary skill in the art.

The cost function γ is adjusted according to the weighting coefficient k in Equation 7, and if the energy e_{d} in the suppression area becomes a very small value that approaches 0 by adjusting the weighting coefficient k, the cost function γ is similar to Equation 5, so a filter coefficient having a high energy efficiency may be achieved. Also, the problem that a high sound pressure level occurs in the suppression area may be suppressed due to the energy e_{d} in the suppression area, which exists in the denominator of the cost function γ.

Equation 8 may be deduced from Equation 7.

((1−k)R_{d}+k∥R_{b}∥²I)⁻¹R_{b}q=γₘₐₓq (8)

Here, γₘₐₓ denotes the maximum eigen value of a matrix ((1−k)R_{d}+k∥R_{b}∥²I)⁻¹R_{b}, and a filter coefficient q(ω) of an angular frequency ω may be determined through an eigen value analyzing method. A method of calculating an eigen value and an eigen vector of a matrix in Equation 8 may be easily understood by those of ordinary skill in the art (refer to P. Lancaster and M. Tismenetsky, The theory of matrices, 2nd edition (Academic Press, San Diego, 1985), pp. 282-294).

The cost function for determining a coefficient of a filter for controlling a sound field has been described. How a characteristic of a sound field control apparatus varies according to a change of the weighting coefficient k will now be described.

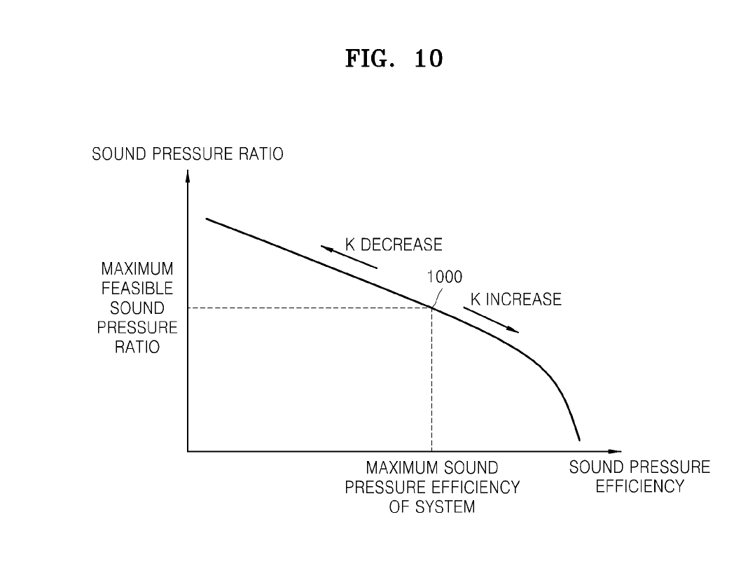

FIG. 10 is a graph for describing a method of determining a weight for a cost function in the sound pressure controller 212 according to an exemplary embodiment, wherein the horizontal axis indicates a sound pressure efficiency, which is a criterion for determining a filter coefficient, and the vertical axis indicates a sound pressure ratio, which is another criterion for determining the filter coefficient. The graph shown in FIG. 10 shows a relationship between a sound pressure efficiency and a sound pressure ratio according to a cost function.

According to the cost function defined by Equation 7, the sound pressure efficiency and the sound pressure ratio have a competition relationship, i.e., they have opposite effects on the weighting coefficient k. Thus, the graph shown in FIG. 10 shows that when the weighting coefficient k increases, the sound pressure efficiency increases whereas the sound pressure ratio decreases, and when the weighting coefficient k decreases, the sound pressure efficiency decreases whereas the sound pressure ratio increases. The sound pressure controller 212 shown in FIG. 8 may determine a proper filter coefficient according to an environment in which the sound field control apparatus is implemented and an embodiment by adjusting the weighting coefficient k of the cost function.

The weighting coefficient k may be determined as a value by which a system can have the maximum sound pressure efficiency and simultaneously have the maximum feasible sound pressure ratio. FIG. 10 shows that the weighting coefficient k corresponding to a specific point 1000 is determined. If the weighting coefficient k is determined, the weighting coefficient k is input to the cost function of Equation 7, and a filter coefficient is calculated through the eigen value analyzing method described above.

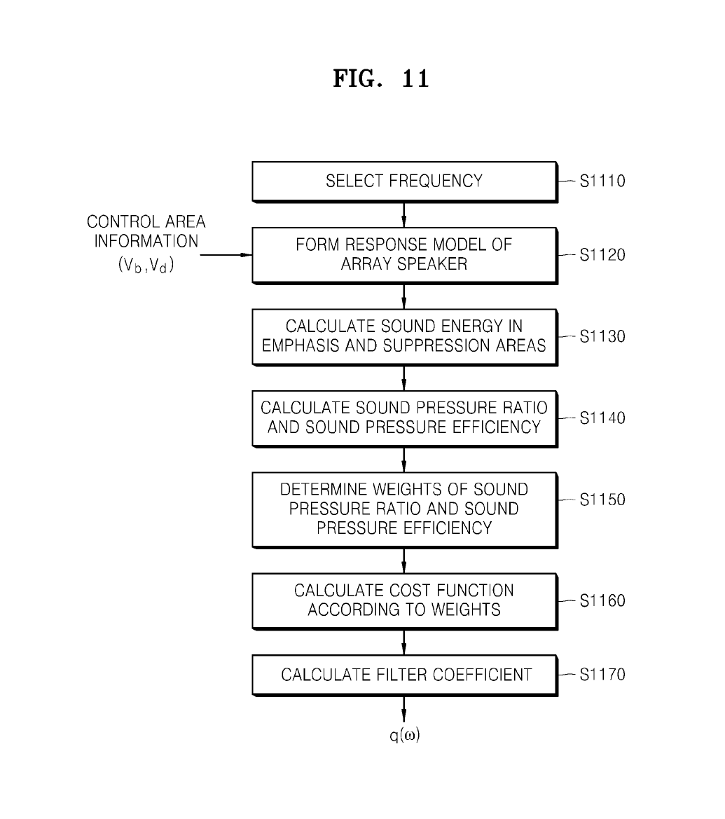

FIG. 11 is a flowchart illustrating a process of calculating a filter coefficient in an apparatus for reproducing a front surround sound according to an exemplary embodiment, wherein the process is applied to frequencies in various bands of an input signal in a frequency domain. A spatial filter of a broadband signal may be formed by calculating a filter coefficient for each frequency under the assumption that the input signal is generally a broadband signal.

Referring to FIG. 11, in operation S1110, a frequency of a signal for which a filter coefficient is calculated is selected from among various frequencies of a sound source signal. Procedures for calculating the filter coefficient for controlling a sound field for the signal of the selected frequency are performed. The procedures will now be described.

In operation S1120, a response model, which is a sound transfer function toward a specific field point around an array speaker, is formed from the array speaker based on information regarding a control area (including a portion of an emphasis area and a suppression area).

In operation S1130, sound energy in the emphasis area and the suppression area is calculated. The sound energy may be calculated by using an arithmetic mean of sound energy induced from a sound pressure, as described with reference to FIG. 9.

In operation S1140, a sound pressure ratio and a sound pressure efficiency are calculated by using the sound energy calculated in operation S1130. The sound pressure ratio and the sound pressure efficiency may be calculated by using Equation 6 and Equation 5.

In operation S1150, weights to be applied to the sound pressure ratio and the sound pressure efficiency are determined. This may be performed by determining weights with values for a system to have the maximum sound pressure efficiency and have the maximum feasible sound pressure ratio.

In operation S1160, a cost function is calculated by combining the sound pressure ratio and the sound pressure efficiency according to the determined weights.

In operation S1170, a filter coefficient for controlling a signal corresponding to the frequency selected in operation S1110 is calculated by using an eigen value analyzing method from the cost function calculated in operation S1170.

The process of calculating a filter coefficient for controlling a sound pressure in the sound pressure controller 212 has been described. The compensator 214, which is the other component of the coefficient determiner 210, will now be described.

The compensator 214 may compensate for the filter coefficient determined by the sound pressure controller 212 so that an output signal to be output from the array speaker is not distorted. As described above, the sound pressure controller 212 calculates the filter coefficient in the frequency domain. Since the output signal to be output from the array speaker must be an analog signal, the input signal is converted from the frequency domain to a time domain, and in this case, distortion or sound quality deterioration may occur in an output signal in the time domain, which is applied to the array speaker. Thus, the compensator 214 performs signal processing to prevent this problem.

A process of compensating for distortion of an output signal in the compensator 214 is achieved by generating a signal so that the output signal possibly has the same waveform as the input signal. For example, if the input signal is an impulse signal, the compensator 214 performs compensation so that the output signal is also an impulse signal.

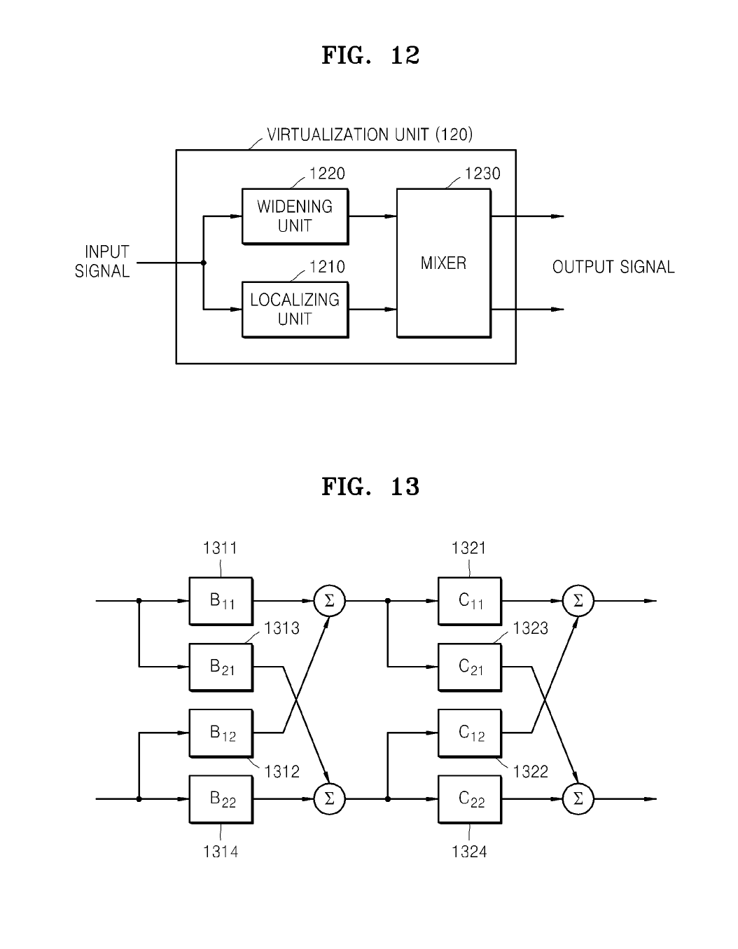

FIG. 12 is a block diagram of the virtualization unit 120 according to an exemplary embodiment.

Referring to FIG. 12, the virtualization unit 120 may include a localizing unit 1210, a widening unit 1220, and a mixer 1230.

The localizing unit 1210 may localize a virtual sound source in the left rear and the right rear of the listener by processing a left rear channel signal and a right rear channel signal.

The localizing unit 1210 may include a binaural synthesis filter implemented with a Head-Related Transfer Function (HRTF) matrix between the virtual sound source and a virtual listener and a crosstalk-canceling filter implemented with an inverse matrix of the HRTF matrix between the virtual listener and a speaker.

The localizing unit 1210 will now be described in detail with reference to FIG. 13. In FIG. 13, B11 1311 denotes an HRTF from a virtual sound source to be localized to the left and to the rear of a left ear, B12 1312 denotes an HRTF from the virtual sound source to be localized to the left and to the rear of a right ear, B21 1313 denotes an HRTF from a virtual sound source to be localized to the right and to the rear of the left ear, and B22 1314 denotes an HRTF from the virtual sound source to be localized to the right and to the rear of the right ear.

An HRTF has a lot of information indicating a time difference between two ears, a level difference between the two ears, a shape of a pinna, and a characteristic of a space through which a sound is delivered. In particular, the HRTF has information regarding the pinna decisively influencing upper and lower sound image localization, and since the modeling of a pinna that has a complicated shape is not easy, an HRTF is mainly obtained through a measurement using a dummy head. Thus, an HRTF is measured at a position at which a virtual sound source is localized.

If a listener hears an output signal of the binaural synthesis filter through a headphone, the listener recognizes that a sound source is generated at a desired position. That is, binaural synthesis technology shows the best performance when reproduction is performed through a headphone. However, if reproduction is performed through two speakers, a crosstalk phenomenon occurs between the two speakers and the two ears, thereby decreasing a localization performance. This is because although a virtual sound source corresponding to a left rear channel should be heard by only a left ear and a virtual sound source corresponding to a right rear channel should be heard by only a right ear, the virtual sound source corresponding to the left rear channel is also heard by the right ear and the virtual sound source corresponding to the right rear channel is also heard by the right ear due to a crosstalk phenomenon between the virtual sound sources.

To cancel the crosstalk phenomenon, HRTFs between a listener and actual speakers must be measured. It is assumed that an HRTF from a speaker located on the left of the listener to a left ear of the listener is H11, an HRTF from the speaker located on the left of the listener to a right ear of the listener is H12, an HRTF from a speaker located in the right of the listener to the left ear of the listener is H21, an HRTF from the speaker located on the right of the listener to the right ear of the listener is H22. In this case, a matrix C(z) of the crosstalk-cancelling filter is designed with an inverse matrix of an HRTF matrix as represented in Equation 9.

$$[ \begin{matrix}{C}_{11} ( z ) & {C}_{12} ( z ) \\ {C}_{21} ( z ) & {C}_{22} ( z )\end{matrix} ] = {[ \begin{matrix}{H}_{11} ( z ) & {H}_{12} ( z ) \\ {H}_{21} ( z ) & {H}_{22} ( z )\end{matrix} ]}^{- 1} \qquad ( 9 )$$

As a result, a total matrix K(z) of the localizing unit 1210 is calculated by multiplying a matrix B(z) of the binaural synthesis filter by the matrix C(z) of the crosstalk-cancelling filter as represented in Equation 10.

$$[ \begin{matrix}{K}_{11} ( z ) & {K}_{12} ( z ) \\ {K}_{21} ( z ) & {K}_{22} ( z )\end{matrix} ] = [ \begin{matrix}{C}_{11} ( z ) & {C}_{12} ( z ) \\ {C}_{21} ( z ) & {C}_{22} ( z )\end{matrix} ] [ \begin{matrix}{B}_{11} ( z ) & {B}_{12} ( z ) \\ {B}_{21} ( z ) & {B}_{22} ( z )\end{matrix} ] \qquad ( 10 )$$

The widening unit 1220 may generate a widening stereo signal by using a left front channel signal and a right front channel signal. The widening unit 1220 may include a widening filter in which left and right binaural synthesizers and a crosstalk canceller are convoluted and a panorama filter in which the widening filter and left and right direct filters are convoluted.

The widening filter may localize a virtual sound source at an arbitrary position by using HRTFs measured at a predetermined position for left and right channel signals L and R and cancel a crosstalk of the virtual sound source based on a filter coefficient on which the HRTFs are reflected.

The left and right direct filters may adjust signal characteristics, such as gain and delay, between an actual sound source and the virtual sound source from which the crosstalk has been cancelled.

According to an exemplary embodiment, the virtualization unit 120 may further include a signal compensator (not shown).

The signal compensator may process a center channel signal C and a low sound range effect channel signal LFE. Left and right rear channel signals Ls and Rs and the left and right front channel signals L and R output through the localizing unit 1210 and the widening unit 1220 have different gains and time delays from those of an initial sound signal. The signal compensator may adjust gains and time delays of the center channel signal C and the low sound range effect channel signal LFE to match to a gain change and a time delay of an output signal output from the localizing unit 1210 and the widening unit 1220.

The mixer 1230 may add left channel signals output from the localizing unit 1210, the signal compensator, and the widening unit 1220 and output the addition signal to a left speaker, and add right channel signals output from the localizing unit 1210, the signal compensator, and the widening unit 1220 and output the added signal to a right speaker.

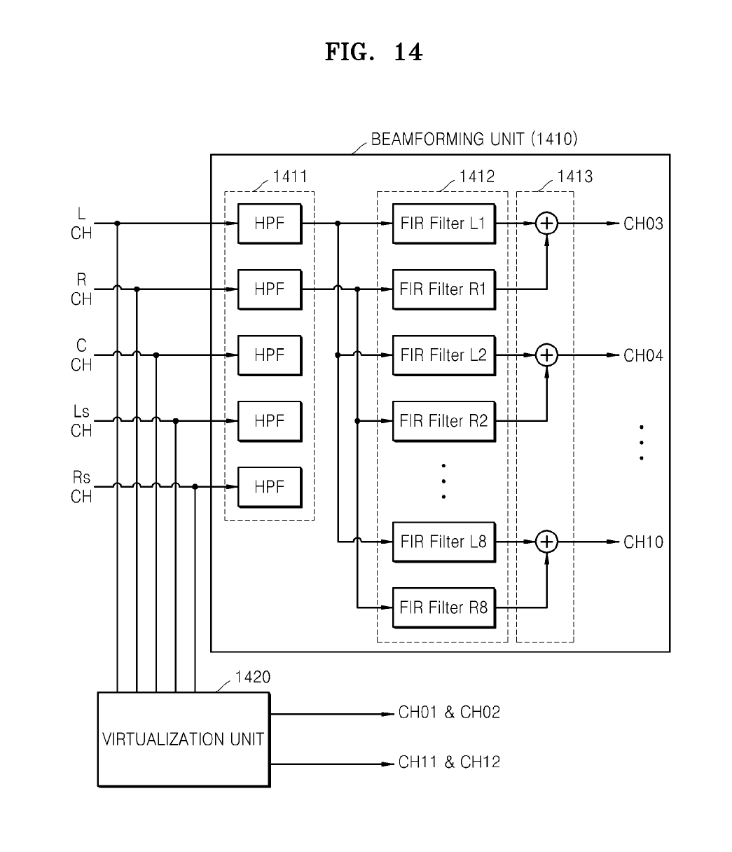

FIG. 14 is a block diagram of an apparatus 1400 for reproducing a front surround sound according to an exemplary embodiment.

The apparatus 1400 may include a beamforming unit 1410 and a virtualization unit 1420.

The beamforming unit 1410 may include an HPF 1411, an FIR filter 1412, and a mixer 1413.

The HPF 1411 may extract only a high frequency component equal to or greater than a threshold from a sound signal. The sound signal passing through the HPF 1411 may be delivered to the HPF 1411.

The FIR filter 1412 may determine the emphasis area, which is the area onto which each channel signal is focused and may determine a coefficient of a corresponding FIR filter 1412 so that each channel signal is focused on the emphasis area. The sound signal passing through the FIR filter 1412 may be delivered to the mixer 1413.

The mixer 1413 may mix sound signals to be output to the same speaker from among the sound signals passing through the FIR filter 1412. The mixer 1413 may output the mixed sound signals to corresponding speakers in an array speaker.

The virtualization unit 1420 may process a sound signal to localize a virtual sound source at positions, which are left and right further apart from positions of speakers to which left and right front channel signals are output, and localize a virtual sound source at predetermined positions in left and right rears of a listener. The virtualization unit 1420 may generate the virtual sound sources by using a low band component or a full band component in the sound signal. The virtualization unit 1420 may output the processed sound signal through a mid-woofer speaker.

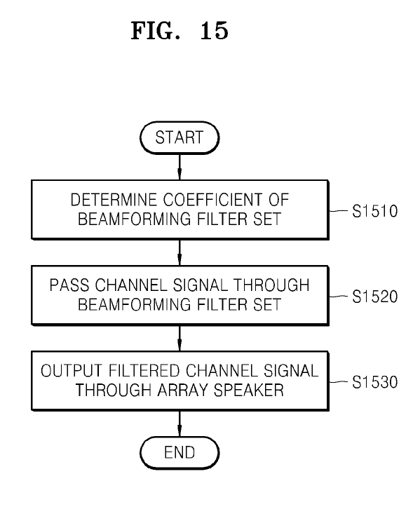

FIG. 15 is a flowchart illustrating a method of reproducing a front surround sound according to an exemplary embodiment.

Referring to FIG. 15, in operation S1510, a coefficient of a beamforming filter set is determined. The beamforming filter set corresponds to each of at least one channel signal included in a sound signal, and coefficients of filters included in the beamforming filter set are determined based on a sound pressure ratio of an emphasis area, which is an area onto which the at least one channel signal is focused, to a suppression area, which is an area in which the delivery of the at least one channel signal is blocked.

In operation S1520, the at least one channel signal passes through a corresponding beamforming filter set.

In operation S1530, the at least one filtered channel signal is output from an array speaker.

Exemplary embodiments described herein can be written as computer programs and can be implemented in general-use digital computers that execute the programs using a computer-readable recording medium. Examples of the computer-readable recording medium include magnetic storage media (e.g., ROM, floppy disks, hard disks, etc.) and optical recording media (e.g., CD-ROMs, or DVDs).

While exemplary embodiments have been particularly shown and described, it will be understood by those skilled in the art that various changes in form and details may be made therein without departing from the spirit and scope of the inventive concept as defined by the appended claims. The exemplary embodiments should be considered in descriptive sense only and not for purposes of limitation. Therefore, the scope of the inventive concept is defined not by the detailed description but by the appended claims, and all differences within the scope will be construed as being included in inventive concept.

What is claimed is:

1. A method of reproducing a front surround sound, the method comprising:
determining a coefficient of at least one beamforming filter set, based on a sound pressure ratio of an emphasis area to a suppression area for each of the at least one channel signal included in a sound signal, wherein the emphasis area is an area into which the at least one channel signal is focused and the suppression area is an area within which the at least one channel signal is blocked;
passing the at least one channel signal through a corresponding beamforming filter set; and
outputting the at least one filtered channel signal through an array speaker.

2. The method of claim 1, wherein the array speaker comprises a plurality of speakers and the beamforming filter set comprises a plurality of filters corresponding to the plurality of speakers, and
the outputting comprises outputting the at least one filtered channel signal through a corresponding one of the plurality of speakers.

3. The method of claim 1, further comprising acquiring a high frequency sound signal from the sound signal, the high frequency sound signal including a frequency component equal to or greater than a threshold frequency,
wherein the passing comprises passing the high frequency sound signal through the corresponding beamforming filter set.

4. The method of claim 1, wherein:
the sound signal comprises residual channel signals and a center channel signal,
the passing comprises passing the residual channel signals through the beamforming filter sets corresponding to the residual channel signals, and
the outputting comprises adding the residual channel signals, which have passed through the beamforming filter set, and the center channel signal and outputting the added signal through the array speaker.

5. The method of claim 1, wherein the determining comprises determining the coefficient of the beamforming filter set based on the sound pressure ratio and a sound pressure efficiency in the emphasis area for each of the at least one channel signal.

6. The method of claim 5, wherein the determining comprises setting the emphasis area and the suppression area for each of the at least one channel signal.

7. The method of claim 5, wherein the determining comprises determining the coefficient so that a phase difference between output signals acquired by applying the same input signal to the plurality of filters in the beamforming filter set varies nonlinearly.

8. The method of claim 1, further comprising:
passing the sound signal through a virtualization filter for localizing a virtual sound source at a predetermined location; and
outputting the sound signal, which has passed through the virtualization filter, through a woofer speaker.

9. The method of claim 8, wherein the passing of the sound signal through the virtualization filter comprises:
cancelling a crosstalk between the at least one virtual sound source localized at the predetermined location; and
compensating for a signal characteristic between the sound signal and the at least one virtual sound source from which the crosstalk is cancelled.

10. The method of claim 9, wherein the cancelling of the crosstalk comprises generating at least one virtual sound source by convoluting Head-Related Transfer Functions measured in the predetermined location and the sound signal.

11. An apparatus for reproducing a front surround sound, the apparatus comprising:
a coefficient determiner which determines a coefficient of at least one beamforming filter set, based on a sound pressure ratio of an emphasis area to a suppression area for each of the at least one channel signal included in a sound signal, wherein the emphasis area is an area into which the at least one channel signal is focused and the suppression area is an area within which the at least one channel signal is blocked;
a beamforming filtering unit comprising at least one beamforming filter set through which a corresponding at least one channel signal is passed; and
an output unit which outputs the at least one filtered channel signal through an array speaker.

12. The apparatus of claim 11, wherein:
the array speaker comprises a plurality of speakers and the at least one beamforming filter set comprises a plurality of filters corresponding to the plurality of speakers, and
the output unit outputs the at least one filtered channel signal through a corresponding one of the plurality of speakers.

13. The apparatus of claim 11, further comprising a high pass filter unit which acquires a high frequency sound signal from the sound signal, the high frequency sound signal including a frequency component equal to or greater than a threshold frequency,
wherein the beamforming filtering unit passes the high frequency sound signal through the corresponding beamforming filter set.

14. The apparatus of claim 11, wherein:
the sound signal comprises residual channel signals and a center channel signal,
the beamforming filtering unit passes the residual channel signals through the beamforming filter sets corresponding to the residual channel signals, and
the output unit adds the residual channel signals, which have passed through the beamforming filter set, and the center channel signal and outputs the addition signal through the array speaker.

15. The apparatus of claim 11, wherein the coefficient determiner determines the coefficient of the beamforming filter set based on the sound pressure ratio and a sound pressure efficiency in the emphasis area for each of the at least one channel signal.

16. The apparatus of claim 15, wherein the coefficient determiner sets the emphasis area and the suppression area for each of the at least one channel signal.

17. The apparatus of claim 15, wherein the coefficient determiner determines the coefficient so that a phase difference between output signals acquired by applying the same input signal to the plurality of filters in the beamforming filter set varies nonlinearly.

18. The apparatus of claim 11, further comprising a virtualization filtering unit which localizes at least one virtual sound source at a predetermined location,
wherein the output unit outputs the sound signal, which has passed through the virtualization filtering unit, through a woofer speaker.

19. The apparatus of claim 18, wherein the virtualization filtering unit comprises:
a crosstalk canceller which cancels a crosstalk between the at least one virtual sound source localized at the predetermined location; and
a compensator which compensates for a signal characteristic between the sound signal and the at least one virtual sound source from which the crosstalk is cancelled.

20. The apparatus of claim 19, wherein the crosstalk canceller generates at least one virtual sound source by convoluting Head-Related Transfer Functions measured in the predetermined location and the sound signal.

21. A computer-readable recording medium storing a computer-readable program for executing the method of claim 1.

22. A surround sound method comprising:
receiving a sound signal comprising at least one channel signal;
determining a sound pressure ratio of a sound pressure in an emphasis area to a sound pressure in a suppression area, wherein the emphasis area is an area into which the at least one channel signal is focused, and the suppression area is an area outside the emphasis area;
determining a coefficient of at least one beamforming filter set based on the sound pressure ratio and a sound pressure efficiency in the emphasis area;
filtering each of the at least one channel signal through a beamforming filter set according to the determined coefficient;
outputting the at least one filtered channel signal through an array speaker.

23. The method of claim 22, wherein the determining the coefficient comprises determining the coefficient to achieve a maximum sound pressure efficiency with a maximum sound pressure ratio.
